(19) United States
(12) Patent Application Publication
(10) Pub. No.: US 2026/0081382 A1
(43) Pub. Date: Mar. 19, 2026

(54) Vehicle Charging Socket and Vehicle

(71) Applicant: Bayerische Motoren Werke Aktiengesellschaft, Muenchen (DE)

(72) Inventor: Niko FONTEIN, Unterschleissheim (DE)

(21) Appl. No.: 19/109,327

(22) PCT Filed: Aug. 3, 2023
(86) PCT No.: PCT/EP2023/071535

§ 371 Date: Mar. 6, 2025

(30) Foreign Application Priority Data
Sep. 8, 2022 (DE) 10 2022 122 763.4

(51) Int. Cl. H01R 13/533; B60L 53/16

(52) U.S. Cl. CPC H01R 13/533; B60L 53/16

(57) ABSTRACT

A vehicle charging socket for an at least partially electrically driven vehicle has at least one direct-current charging contact that extends from an exterior of the vehicle towards the interior of the vehicle. The vehicle charging socket has, within a charging socket housing, a cavity through which the at least one direct-current charging contact extends. The cavity is designed as a cooling channel that has a first end allocated to the interior of the vehicle, and a second end allocated to the exterior of the vehicle. The vehicle charging socket has a fan that is allocated to the cooling channel and is configured to draw in air from the interior of the vehicle via the first end of the cooling channel and discharge same via the second end of the cooling channel in order to cool the direct-current charging contact.

### BACKGROUND AND SUMMARY

The invention relates to a vehicle charging socket for an at least partially electrically driven vehicle, and to a vehicle having such a vehicle charging socket.

Vehicles which are at least partially electrically driven are customarily equipped with an electrically powered drive machine, which is supplied with electricity by means of a battery device, for example by means of a rechargeable traction battery. In order to charge the battery device, the latter can be connected to an external charging device, such as a charging column. To this end, it is known for a vehicle charging socket to be provided on the vehicle, which charging socket has charging contacts by means of which the vehicle can be electrically contact-connected to the respective charging device during the charging process.

As a result of the current flux which is generated during the charging process, the charging contacts of the vehicle charging socket undergo heat-up. This effect is of particular significance in direct-current charging contacts, via which a direct current having a current intensity of the order of up to 200 A can flow. In fulfilment of future requirements, moreover, current intensities of up to 500 A and higher, will be sought for vehicle applications. In the event of an excessively high rise in temperature of direct-current charging contacts, it is necessary for the current flux to be reduced, in order to prevent an overshoot of a stipulated temperature threshold. However, this reduction impacts negatively upon the duration of charging of the vehicle or of the battery device, such that the minimum charging time is restricted by the temperature of the direct-current charging contacts.

It is known for the vehicle charging socket to be equipped with a facility for cooling the direct-current charging contacts, in order to counteract the heat-up of direct-current charging contacts. To this end, the vehicle charging socket can be provided with a water cooler, an air cooler, or a cooling system based upon a phase-change material, which absorbs heat from the direct-current charging contacts and executes the release thereof in the direction of the interior of the vehicle, customarily into a luggage space of the vehicle. Known solutions, however, are disadvantageous in that the respective cooling systems are complex, and in that heat released into the interior of the vehicle heats up the interior of the vehicle. In consequence, an air-conditioning system of the vehicle will assume a higher energy consumption, in order to offset the additional release of heat into the interior.

The object of the invention is the disclosure of a cost-effective vehicle charging socket for an at least partially electrically powered vehicle, which enables an efficient cooling of direct-current charging contacts.

This object is fulfilled by a vehicle charging socket for an at least partially electrically driven vehicle, wherein the vehicle charging socket comprises at least one direct-current charging contact, which extends from an exterior of the vehicle towards the interior of the vehicle. Within a charging socket housing, the vehicle charging socket incorporates a cavity through which the at least one direct-current charging contact extends, wherein the cavity is configured as a cooling duct, having a first end which is allocated to the interior of the vehicle, and a second end which is allocated to the exterior of the vehicle. The vehicle charging socket comprises a fan which is allocated to the cooling duct, and which is configured to draw in air from the interior of the vehicle via the first end of the cooling duct, and to execute the discharge thereof via the second end of the cooling duct, in order to cool the direct-current charging contact.

The invention is based upon the fundamental concept whereby the at least one direct-current charging contact is cooled by means of air which is drawn in from the interior of the vehicle. Conversely to air which is fed in from the exterior of the vehicle, air in the interior of the vehicle customarily has a lower water content and contains a lower quantity of contaminants such that, during the operation of the vehicle charging socket, the cooling duct is less susceptible to fouling and the accumulation of moisture in the cooling duct is less probable. At the same time, the vehicle charging socket according to the invention can be produced in a cost-effective and simple manner, as it is only necessary for the fan to be installed during the assembly of the vehicle charging socket.

Air which is drawn in by the fan flows directly around the at least one direct-current charging contact, or around a thermally conductive housing of the at least one direct-current charging contact, such that effective cooling is ensured by the air stream thus generated.

In the installation position of the vehicle charging socket, the first end of the cooling duct is fluidically connected to the interior of the vehicle and, in the installation position of the vehicle charging socket, the second end of the cooling duct is fluidically connected to the exterior of the vehicle.

In the present context, and hereinafter, relations indicated between components of the vehicle charging socket and the vehicle refer to the installation position of the vehicle charging socket according to the invention in a corresponding vehicle.

In order to enable air to be drawn from the interior of the vehicle in a particularly reliable manner, the fan can be arranged in the region of the first end of the cooling duct.

For example, the charging socket housing can comprise a sealing surface which adjoins the interior of the vehicle and which delimits the cavity, wherein the fan is an element of the sealing surface. In other words, in this variant, in the installation position, the sealing surface of the vehicle charging socket is directly adjacent to the interior of the vehicle, for example to the luggage space of the vehicle.

The first end of the cooling duct is preferably arranged geodetically above the second end of the cooling duct. In this manner, the air stream which is generated by the fan is directed from the top downwards. This enables the assumption by the second end of the cooling duct, i.e. that end which is allocated to the exterior of the vehicle, of a downwardly oriented outlet opening, via which the air stream is discharged over the exterior of the vehicle. It is thus not necessary for any upwardly oriented outlet opening to be provided, via which soiling and/or humidity, for example associated with rainwater, can penetrate the cooling duct.

In one variant, in the region of the at least one direct-current charging contact, the cooling duct is oriented perpendicularly to the at least one direct-current charging contact. In this manner, a particularly compact design of the vehicle charging socket is achieved.

Moreover, at least one part of the cooling duct can constitute a water drain of the vehicle charging socket housing, or can be oriented in parallel with a water drain of the vehicle charging socket housing. In other words, a water drain which is already provided for protection against humidity can simultaneously be co-employed as a cooling duct, such that structural space required for the vehicle charging socket can be further minimized.

In order to enable an even more effective regulation of the temperature of the at least one direct-current charging contact, the speed of rotation of the fan can be controllable according to the instantaneous temperature of the at least one direct-current charging contact.

In particular, the vehicle charging socket comprises a control unit, which is designed to control the speed of rotation of the fan.

Alternatively, the fan of the vehicle charging socket can be connected to a control unit of the vehicle, which is designed to control the speed of rotation of the fan.

For example, the speed of rotation of the fan can be increased, in the event that the instantaneous temperature of the at least one direct-current charging contact rises, and reduced in the event that the instantaneous temperature of the at least one direct-current charging contact is constant, or falls.

In the control unit, a temperature threshold of the at least one direct-current charging contact can be saved, by reference to which the speed of rotation of the fan is controllable. In other words, control of the fan can be executed such that the at least one direct-current charging contact does not undergo heat-up to a temperature in excess of the temperature threshold.

For example, the temperature threshold is a temperature of 90° C.

The vehicle charging socket can be provided with a sensor unit, which is designed to determine the instantaneous temperature of the at least one direct-current charging contact, and to execute the communication of this temperature to the control unit.

Control of the fan can also be executed such that the fan can be completely shut down. This is particularly advantageous if the vehicle charging socket, additionally to the at least one direct-current charging contact, is provided with at least one alternating-current charging contact, such that an alternating-current charging operation is enabled. In an alternating-current charging operation, lower currents flow via the at least one alternating-current charging contact than in the case of a direct-current charging operation via the at least one direct-current charging contact. In this case, it is desirable that as many loads as possible in the vehicle are disconnectable, in order to restrict the loss of electric power during the charging process to a minimum.

The fan can assume a maximum power consumption of 5 W or lower, in particular of 2 W or lower, for example of 1.5 W. In this manner, the energy demand of the fan is negligibly low. Moreover, fans of this type are globally and cost-effectively available, and require a limited structural space.

It has been observed that a correspondingly dimensioned fan is sufficient for the achievement of the desired cooling action on the at least one direct-current charging contact, as the temperature difference between the air in the interior and the temperature threshold, i.e. the maximum anticipated temperature of the at least one direct-current charging contact, is sufficiently high to enable the reliable cooling of the at least one direct-current charging contact by means of an air stream which can be generated by a fan of this type.

For example, the temperature difference at an interior temperature in the range of 20 to 40° C., and subject to a temperature threshold of 90° C., lies within a range of 50 to 70° C.

Moreover, the fan can assume an operating voltage of 12 V, such that the fan is operable by means of the on-board electrical network of the vehicle. The employment of converters for the operation of the fan can thus be omitted, as a result of which costs and/or space requirements for the vehicle charging socket can be further reduced.

According to the invention, the object is further fulfilled by a vehicle having a vehicle charging socket as described above.

The advantages and properties of the vehicle charging socket according to the invention apply in an analogous manner to the vehicle according to the invention, and vice versa, wherein reference may be made to the above-mentioned explanations.

In particular, the vehicle is an electric vehicle or a plug-in hybrid vehicle. Further advantages and properties of the invention proceed from the following description of one exemplary embodiment, which is not to be understood by way of limitation, and from the drawings.

### BRIEF DESCRIPTION OF THE DRAWINGS

FIG. 1 is a schematic representation of a vehicle according to an embodiment of the invention; and

FIG. 2 is a perspective sectional view of a vehicle charging socket according to an embodiment of the invention, of a type which is employed in the vehicle according to FIG. 1.

### DETAILED DESCRIPTION OF THE DRAWINGS

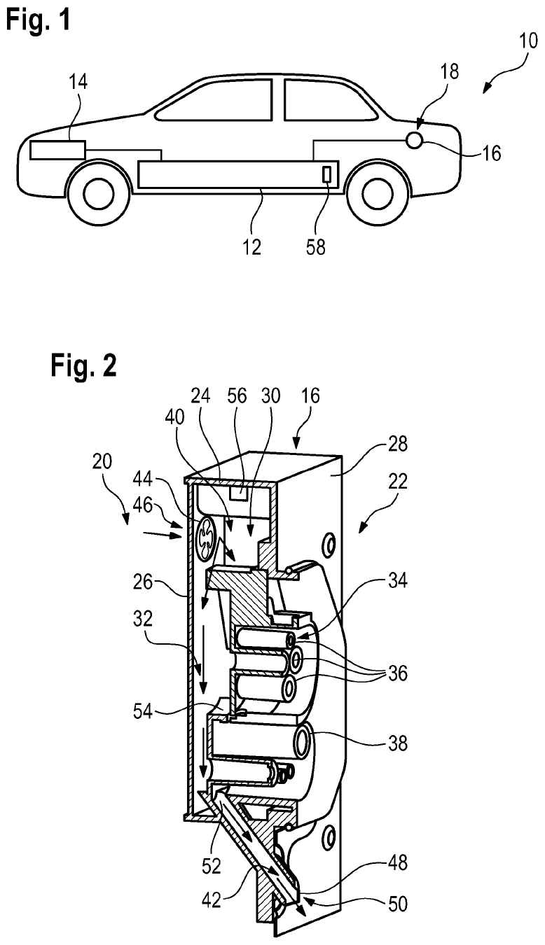

FIG. 1 shows a schematic representation of a vehicle 10. The vehicle 10 is an at least partially electrically driven vehicle, for example a plug-in hybrid vehicle or an electric vehicle.

The vehicle 10 is provided with a rechargeable battery device 12, which is connected to an electrically powered drive device 14, by means of which the vehicle 10 can be propelled.

The vehicle 10 is further provided with a vehicle charging socket 16, which is arranged in the region of a luggage space 18 of the vehicle 10. It is understood that the vehicle charging socket 16 can also be arranged at a different location in the vehicle 10 to that represented in FIG. 1.

FIG. 2 shows a perspective sectional view of the vehicle charging socket 16, wherein the section plane is oriented transversely to the longitudinal vehicle axis of the vehicle 10, such that an interior 20 of the vehicle 10, according to FIG. 2, adjoins the vehicle charging socket 16 represented to the left, and an exterior 22 of the vehicle 10, according to FIG. 2, adjoins the vehicle charging socket 16 represented to the right.

The vehicle charging socket 16 is provided with a charging socket housing 24, which adjoins the interior 20 of the vehicle 10 at a sealing surface 26 and, at an outer surface 28, executes a closure in the direction of the exterior 22 of the vehicle 10.

Within the charging socket housing 24, a cavity 30 is provided, which is configured as a cooling duct 32, as described in greater detail hereinafter.

The vehicle charging socket 16 is further provided with a charging terminal 34, which comprises a multiplicity of alternating-current charging contacts 36 and two direct-current charging contacts 38 wherein, on the grounds of the sectional representation shown in FIG. 2, only a portion of the alternating-current charging contacts 36 and of the direct-current charging contacts 38 is visible.

In the embodiment represented, the charging terminal 34 is configured in accordance with the CCS standard (CCS stands for “Combined Charging System”). In principle, however, according to the invention, different arrangements of alternating-current charging contacts 36 and of direct-current charging contacts 38 are also possible, provided that at least one direct-current charging contact 38 is present.

The respective alternating-current charging contacts 36 and direct-current charging contacts 38 extend parallel to the section plane represented in FIG. 2, i.e. from the exterior 22 of the vehicle 10 in the direction of the interior 20 of the vehicle 10.

In the interior 20, the alternating-current charging contacts 36 and direct-current charging contacts 38 execute a transition to electrical conductors, which are connected to the battery device 12 (see FIG. 1).

The cooling duct 32 extends from a first end 40, which is allocated to the interior 20, to a second end 42, which is allocated to the exterior 22.

A fan 44 is allocated to the first end 40, which fan forms a fluidic connection between atmospheric air in the interior 20 of the vehicle, namely, atmospheric air in the luggage space 18, and the cooling duct 32.

In other words, in the embodiment represented, the fan 44 forms an inlet 46 of the cooling duct 32.

The fan 44 assumes a maximum power consumption of 5 W or lower, in particular of 2 W or lower, for example of 1.5 W, and assumes an operating voltage of 12 V, such that the fan 44 can be operated, with a low energy demand, using the on-board electrical network of the vehicle 10.

The second end 42 is formed by a shaft 48 which is oriented obliquely downwards, and which thus functions as an outlet 50 of the cooling duct 32.

The shaft 48 simultaneously forms a water drain 52 of the charging socket housing 24. This means that, in the event that water is precipitated within the cavity 30, this water can be discharged to the exterior via the shaft 48.

The operating method of the vehicle charging socket 16 is described in greater detail hereinafter.

By means of the electrical contacts available, the vehicle charging socket 16 enables various modes for the charging of the battery device 12.

On the one hand, by means of the alternating-current charging contacts 36, the vehicle charging socket 16 can be employed in an alternating-current charging operation, also described as an AC charging operation. In an alternating-current charging operation, comparatively low currents, for example up to 80 A, are employed for charging the battery device 12.

On the other hand, by means of the direct-current charging contacts 38, the vehicle charging socket 16 can be employed in a direct-current charging operation, also described as a DC charging operation. In a direct-current charging operation, comparatively high currents of up to 500 A, for example 200 A, are employed for charging the battery device 12.

As a result of the current flux associated with the charging process, the alternating-current charging contacts 36 and the direct-current charging contacts 38 undergo heat-up, wherein it is necessary for the temperatures of the alternating-current charging contacts 36 and of the direct-current charging contacts 38 to be maintained below a stipulated temperature threshold, in order to ensure the security and reliability of the vehicle charging socket 16. As a result, in a direct-current charging operation, the current intensity which can actually be employed over a full charging process of the battery device 12, and thus the overall duration of the charging process, is primarily restricted by the temperature of the direct-current charging contacts 38.

In particular, it is necessary for the instantaneous temperature, i.e. the temperature at a specific time point in the charging process, to be maintained below a stipulated temperature threshold, for example at a temperature not exceeding 90° C. Were this temperature threshold to be exceeded, it would be necessary for the current intensity to be reduced.

In order to counteract this effect by means of the fan 44, air is drawn in from the interior of the vehicle 10, which air customarily assumes a temperature within the range of 20 to 40° C.

Air which is drawn in by the fan 44 flows from the first end 40 of the cooling duct 32 in the direction of the second end 42 of the cooling duct 32, and thus passes the direct-current charging contacts 38, as indicated by the arrow in FIG. 2. In this manner, heat can be released from the direct-current charging contacts 38 to the air which flows through the cooling duct 32, such that air at the outlet 50 assumes a higher temperature than at the inlet 46, and the direct-current charging contacts 38 are cooled.

In the region of the direct-current charging contacts 38, the cooling duct 32 is oriented perpendicularly to the direction of extension of the direct-current charging contacts 38, such that a compact design of the vehicle charging socket 16 is realized, wherein a high efficiency of cooling is simultaneously ensured.

As can be seen in FIG. 2, the direct-current charging contact 38 is enclosed by a housing 54, which is employed for protecting the direct-current charging contacts 38 against humidity and soiling. Correspondingly, heat evacuation from the direct-current charging contacts 38 to the passing air stream is executed via the housing 54.

The representation according to FIG. 2 also illustrates the orientation of the air stream within the cooling duct 32 from top to bottom, as the vehicle charging socket 16 is installed in the vehicle such that the first end 40 is arranged geodetically above the second end 42 of the cooling duct 32.

The fan 44 is moreover designed such that the speed of rotation of the fan 44, and thus the rate of flow and/or the throughflow volume of air per unit of time, is controllable according to the instantaneous temperature of the direct-current charging contacts 38.

To this end, the vehicle charging socket 16 is provided with a control unit 56, which is represented in a schematic manner only, which can retrieve information on the instantaneous temperature of the direct-current charging contacts 38 and is configured to transmit control signals to the fan 44.

It is understood that the control unit 56 might also be arranged at a different location to that indicated in FIG. 2. It is also possible that control of the fan 44 is assumed by a further control unit of the vehicle 10, for example a battery control unit 58 of the battery device 12 (see FIG. 1).

For example, the speed of rotation of the fan 44 is increased, in the event that the instantaneous temperature of the direct-current charging contacts 38 approaches the temperature threshold, and the speed of rotation of the fan 44 is reduced, in the event that the instantaneous temperature falls again.

In particular, control of the fan 44 is governed by that direct-current charging contact 38 which respectively assumes the highest instantaneous temperature, in order to ensure that none of the direct-current charging contacts 38 exceeds the temperature threshold.

If the vehicle charging socket 16 is operated in an alternating-current charging operation, the fan 44, in particular, is completely shut down, in order to minimize the number of loads in the vehicle 10. This is possible, as the alternating-current charging contacts 36, on the grounds of the lower current intensity associated with an alternating-current charging operation, do not customarily achieve the temperature threshold.

The vehicle charging socket 16 is distinguished by a compact structural design, a simple layout and a reliable cooling of direct-current charging contacts 38.

1.-9. (canceled)

10. A vehicle charging socket for an at least partially electrically driven vehicle, comprising:
at least one direct-current charging contact extending from an exterior of the vehicle towards an interior of the vehicle;
a charging socket housing within which the vehicle charging socket incorporates a cavity through which the at least one direct-current charging contact extends, wherein the cavity is configured as a cooling duct, having a first end which is allocated to the interior of the vehicle, and a second end which is allocated to the exterior of the vehicle; and
a fan which is allocated to the cooling duct, the fan being configured to draw in air from the interior of the vehicle via the first end of the cooling duct and discharge the air via the second end of the cooling duct, in order to cool the at least one direct-current charging contact.

11. The vehicle charging socket according to claim 10, wherein the fan is arranged in a region of the first end of the cooling duct.

12. The vehicle charging socket according to claim 10, wherein the first end of the cooling duct is arranged geodetically above the second end of the cooling duct.

13. The vehicle charging socket according to claim 10, wherein
the cooling duct is oriented perpendicularly to the at least one direct-current charging contact in a region of the at least one direct-current charging contact.

14. The vehicle charging socket according to claim 10, wherein
at least one part of the cooling duct constitutes a water drain of the charging socket housing, or is oriented in parallel with a water drain of the charging socket housing.

15. The vehicle charging socket according to claim 10, wherein
a speed of rotation of the fan is controllable according to an instantaneous temperature of the at least one direct-current charging contact.

16. The vehicle charging socket according to claim 10, wherein the fan assumes a maximum power consumption of 5 W or lower.

17. The vehicle charging socket according to claim 10, wherein the fan assumes an operating voltage of 12 V.

18. A vehicle comprising a vehicle charging socket according to claim 10.
